(19) United States
(12) Patent Application Publication
(10) Pub. No.: US 2014/0372261 A1
(43) Pub. Date: Dec. 18, 2014

(54) SYSTEM AND/OR METHOD FOR DETERMINING NEEDS AND ABILITY ASSESSMENT

(71) Applicant: Mastercard International Incorporated, Purchase, NY (US)

(72) Inventors: Robert Snyder, Monsey, NJ (US); Edward Downs, River Vale, NJ (US)

(21) Appl. No.: 13/920,856

(22) Filed: Jun. 18, 2013

(51) Int. Cl. G06Q 40/00

(52) U.S. Cl. CPC G06Q 40/12
USPC 705/30

(57) ABSTRACT

A system and a method are disclosed for accessing the need and ability of an organization such as a business to use a financial product. The need is related to the length of time it takes the organization to receive payment after making a sale, and whether the organization receives payment for the sale. The need is greatest for an organization with a high bad debt ratio or slow average time until payment is received. The ability of the organization to pay for the financial product is greater when gross profit margin is high. The total volume of sale can also be taken into account in determining whether the organization can use the financial product.

### BACKGROUND OF THE DISCLOSURE

1. Field of the Disclosure

The present disclosure relates to a system and/or a method for determining needs of a business for financial products, and the ability of the business to utilize such financial products. More particularly, the present disclosure relates to a system and/or a method of determining which business can profit from using a financial product.

2. Description of the Related Art

In the normal course of operation, a business accumulates accounts receivable and accounts payable. The amount of each, the time needed to collect accounts receivable, and the specific dates when accounts must be paid, can all have a profound effect on the operation of the business and its profitability.

There are specific financial products available on the market that can assist a business to speed up the collection of receivables. A simple example is the acceptance of payment cards, which can assure a merchant of being promptly paid.

One traditional assessment is the opportunity assessment: whether a business should use one of these financial products based entirely on the volume of the business. However, volume is not necessarily representative of whether a particular financial product can help a business, or whether a business can afford the product. For example, the acceptance of a credit card payment from a customer of a business will speed up collection of accounts receivable, but imposes a charge of approximately two to three percent on the payment. If the gross margin of the business is very small, then the business may be less inclined to accept the financial product.

Thus, there is a need for a more sophisticated approach to determining whether a business should use a particular financial product in its operations. The use of a better approach not only assists a business in evaluating whether to use a particular financial product, but also assists those selling or recommending a financial product in targeting businesses that can most profit from that financial product.

### SUMMARY OF THE DISCLOSURE

The present disclosure provides a system and/or a method for determining whether an organization, such as a business, or a group of such organizations, can profit from a particular financial product based on the need of the organization or business for the product, and the ability of the business to use the product. The need is greatest for an organization with a slow average payment time, i.e. customers that pay slowly or not at all. The ability of the organization to pay for the financial product is greater when gross profit margin is high and there is an ability to afford the acceptance cost of the financial product.

The present disclosure also provides that the system and/or method can evaluate based on a group of businesses in a particular category, such as, by way of example, only, the North American Industry Classification System (NAICS) category, or businesses all having the same NAICS code.

The present disclosure still further provides that the system and/or method can, in order to decide whether a financial product sale organization should target one or more particular industries or businesses, evaluate total sales volume and sales of a given organization.

The present disclosure in another embodiment provides a computer readable non-transitory storage medium storing instructions of a computer program which when executed by a computer system results in performance of the methods disclosed herein.

### BRIEF DESCRIPTION OF THE DRAWINGS

FIG. 1 is a block diagram of computer system that is used to implement the embodiment described herein.

FIG. 2 is a flow chart of the steps performed by the system of FIG. 1 to implement the embodiment described herein.

FIGS. 3A and 3B represent portions of a spreadsheet that can be assembled from left to right, respectively, to illustrates the generation of a score based on ability to pay and need.

A component or a feature that is common to more than one drawing is indicated with the same reference number in each of the drawings.

### DESCRIPTION OF THE EMBODIMENTS

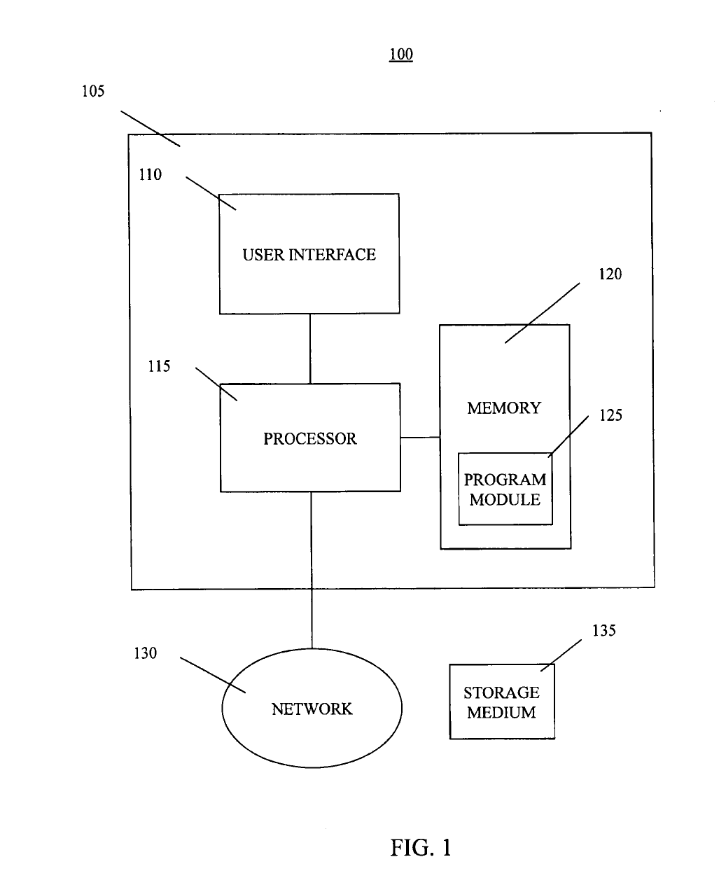

Referring to the drawings and, in particular, FIG. 1, there is shown a system generally represented by reference numeral 100 of the present disclosure. System 100 includes a computer 105 coupled to a network 130, e.g. the Internet.

Computer 105 includes a user interface 110, a processor 115, and a memory 120. Computer 105 may be implemented on a general-purpose microcomputer. Although computer 105 is represented herein as a standalone device, it is not limited to such, but instead can be coupled to other devices (not shown) via network 130.

Processor 115 is configured with logic circuitry that responds to and executes instructions.

Memory 120 stores data and instructions for controlling the operation of processor 115. Memory 120 may be implemented in a random access memory (RAM), a hard drive, a read only memory (ROM), or a combination thereof. One component of memory 120 is a program module 125.

Program module 125 contains instructions for controlling processor 115 to execute the methods described herein. For example, as a result of execution of program module 125, processor 115 can provide a score, that is an indication based on need and ability to pay. The indication illustrates whether an organization could profit from using a particular financial product. Such a financial product includes, but is not limited to, a payment card in the form of a credit card, a debit card, or a prepaid payment card.

The term “module” is used herein to denote a functional operation that may be embodied either as a stand-alone component or as an integrated configuration of a plurality of sub-ordinate components. Thus, program module 125 may be implemented as a single module or as a plurality of modules that operate in cooperation with one another. Moreover, although program module 125 is described herein as installed in memory 120, and therefore being implemented in software, it could be implemented in anyone of hardware (e.g., electronic circuitry), firmware, software, or any combination thereof.

User interface 110 includes an input device, such as a keyboard or speech recognition subsystem, for enabling a user to communicate information and command selections to processor 115. Specifically, data to be used to implement the methods described herein can be entered with user interface 110, or can be downloaded from a network 130. User interface 110 also includes an output device including, but not limited to, a display or a printer. A cursor control including, but not limited to, a mouse, track-ball, or joy stick, allows the user to manipulate a cursor on the display for communicating additional information and command selections to processor 115.

Processor 115 outputs to user interface 110, a result of an execution of the methods described herein. Alternatively, processor 115 could direct the output to a remote device (not shown) via network 130.

While program module 125 is shown as already loaded into memory 120, program module 125 may be configured on a storage medium 135 for subsequent loading into memory 120. Storage medium 135 can be any conventional storage medium that stores program module 125 thereon in tangible form. Examples of storage medium 135 include, but are not limited to, a floppy disk, a compact disk, a magnetic tape, a read only memory, an optical storage media, universal serial bus (USB) flash drive, a digital versatile disc, and a zip drive. Alternatively, storage medium 135 can be a random access memory or other type of electronic storage, located on a remote storage system and coupled to computer 105 via network 130.

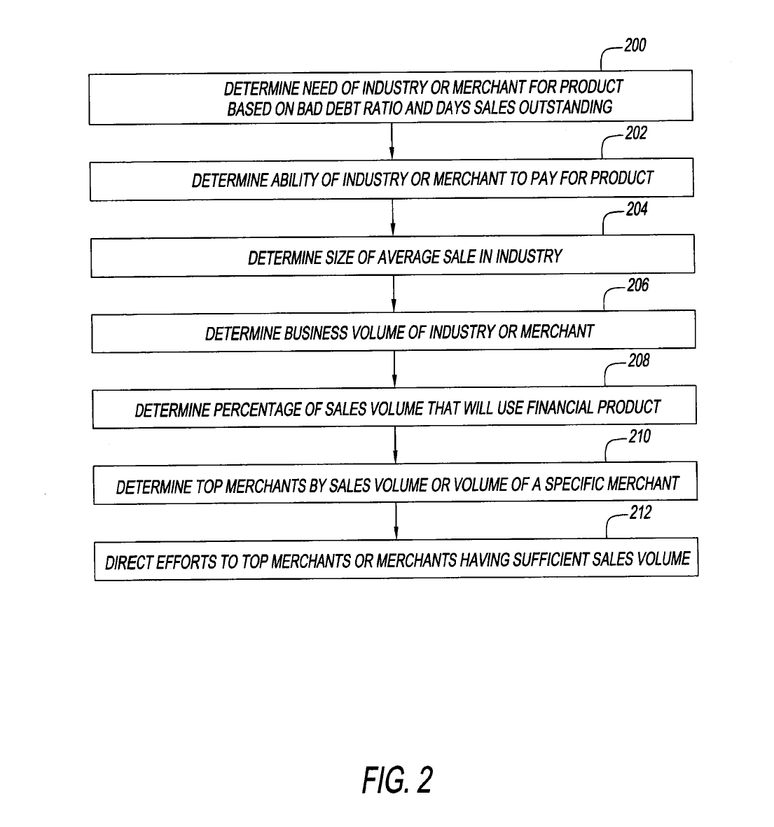

Referring to FIG. 2, an embodiment of the method disclosed herein is shown in its implementation steps. The method can be applied to an entire industry based on those companies with a specific North American Industry Classification System (NAICS) code (the system that has generally replaced the Standard Industrial Classification (SIC) system. In the alternative, the method may be applied to a specific merchant. In particular, the method can be applied to top ranking merchants in an industry or merchants characterized by a specific NAICS code and having the largest volume of sales. Generally, the method will first be applied to an entire industry. If the results are promising for the use of a financial product by that industry, the method will then be applied to the top merchants in that industry. Alternatively, the method can be used by one or more individual organizations or companies, or those advising or selling financial products to such organizations or companies, in order to determine whether the organization or company can profit from the use of the financial product.

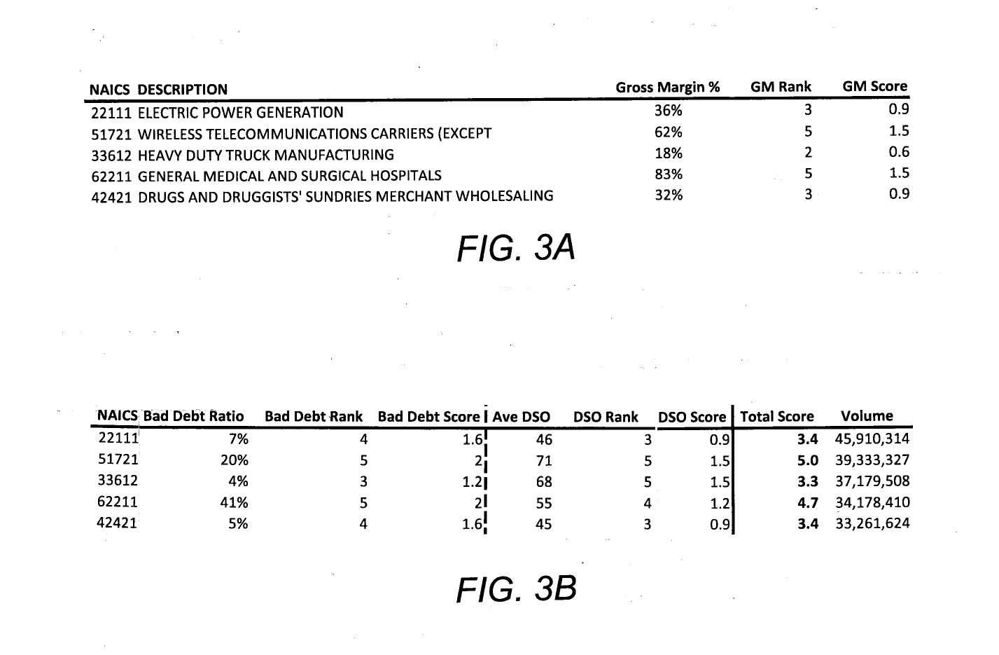

The present method can be implemented on the computer system of FIG. 1 by using appropriate software that has been loaded thereon, such as, for example, a spreadsheet program, such as Microsoft's Excel®. However, it should be understood that any suitable spreadsheet program may be used. Examples of the manner in which the program can be implemented are discussed below with respect to FIGS. 3 and 4.

In accordance with the present method, the following relationship is used to provide a score for whether an organization or business can profit from a financial product:

Total Score=Need Ranking*Need weight+Ability Ranking*Ability Weight

Need has components of the average number of days sales are outstanding (DSO) and bad debt ratio. DSO is the average number of days from when a sale is made until payment is received. If the average amount of time from invoicing until collection is too long, some organizations can be very short on cash needed to meet expenses, and their balance sheets may be adversely affected (although other business may be able meet their expenses by financing). Thus, there can be adverse consequences. In those situations, the need for the financial product would be great. Bad debt serves as another indicator of “need”. Bad debt ratio can be measured in a few different ways (for example, as a percentage of sales, or as a percentage of accounts receivable) but ultimately it is a measure of what revenues a company is unable to collect. Companies with high bad debt ratios would want to consider credit card programs that offer them guaranteed payment where the credit card issuer is intermediating, and thus taking the bad debt risk. For purposes of this description, debt can be considered as bad when not paid after a predetermined number of days, such as for example, 90 days.

Total Score=Bad Debt Ranking*Bad Debt Weight+Average DSO*DSO Weight+Ability Ranking*Ability Weight

In this relationship, the following weights are assigned based on business intuition concerning relative importance of the factors. However, different weights may be selected based on experience, or based on the requirements of a particular industry. Thus, other weights may be used and found to be more accurate in certain circumstances. For example, some merchants may not closely track their acceptance costs but they may be very focused on their accounts receivable (i.e. need) issues.

Bad Debt Weight=0.4

DSO Weight=0.30

Ability Ranking=0.30

The relationship above becomes:

Total Score=0.4*Bad Debt Ranking+0.30*Need Ranking+0.30*Ability Ranking

Referring to FIG. 2, at 200, the need of a merchant or merchants in a particular business based on NAICS codes for a particular financial product is determined. The need is generally assessed in terms of the average number of days sales are outstanding (DSO) and bad debt ratio, as discussed above.

At 200, a need ranking can be established by the following relationships, as set forth in Tables I and II:

TABLE I
Bad Debt Ranking Factors

| Bad Debt | Bad Debt |
|---|---|
| Ratio | Ranking Factor |
| 0.50-0.99% | 1 |
| 1.00-2.99% | 2 |
| 3.00-4.99% | 3 |
| 5.00-8.00% | 4 |
| More than 8.00% | 5 |

TABLE II
DSO (or Payment Delay) Ranking Factors

| Average DSO (days) | DSO Ranking Factor |
|---|---|
| less than 30 | 1 |
| 30-44 | 2 |
| 45-55 | 3 |
| 56-65 | 4 |
| 65+ | 5 |

At 202, an ability ranking of the organization to pay for the financial product is determined by reference to Table III. The greater the gross margin, the greater the ability of the organization to pay the fees associated with a financial product.

TABLE III
Ability Ranking Factors

| Gross Margin (in %) | Ability Ranking Factor |
|---|---|
| less than 20 | 1 |
| 20-29 | 2 |
| 30-39 | 3 |
| 40-50 | 4 |
| More than 50 | 5 |

The rankings in the above tables are based on Cross-NAICS Averages for DSO (52 days), gross margin (35%), and bad debt (3%) for a wide range of industries. Tables I, II, III are based on these averages, in that the average values fall in the range that provides a ranking of 3, in the respective table. The score will generally be obtained for a given industry. Thus, the score is derived for all businesses for which data is available having the same NAICS code.

At 206, a determination is made as to the business volume of the industry (or of a particular merchant, if the method is being used with respect to that merchant). If there is sufficient volume, then it generally can be assumed that the industry is worth exploring with respect to sales of a financial product to that industry,

At 208, a determination is made as to the percentage of sales volume that will use the financial product. For example, what percentage of the transactions will be made using a payment card. Source data useful for this analysis may include, but is not limited to, businesses with enterprise resource planning (ERP) systems, known percentages in a mature credit card industry, or secondary sources such as Wholesale Distribution Economic Reports (WDER) available from Modern Distribution Management (MDM) of Boulder, Colo.

If the volume of business that will use the financial product is significant, then a determination can be made at 210 as to which merchants are the top merchants, as measured by sales volume. A variety of industry data sources can be used to obtain the data required to make this determination. The top merchants can be, for example, the top ten merchants based on sales volume.

At 212, sales efforts for the financial product are directed to the top merchants as determined at 210, or to additional merchants having sufficient sales volume to justify sales efforts.

The columns in FIGS. 3A and, 3B, when assembled, from left to right show, for each industry, NAICS code, a description of the industry, percentage gross margin, gross margin ranking, gross margin score, bad debt ratio, bad debt ranking, bad debt score, average DSO, DSO ranking, total score and total sales volume. For clarity, the NAICS codes are repeated in FIG. 3B, but such repetition is not required.

### Example

Referring to FIGS. 3A and 3B, the NAICS code for Electric Power Generation (22111) ranks well across Need and Ability indicators. Average bad debt is 7%, which has a ranking of 4 in Table I. Average Days Receivable of forty-six (46) days that is within average, resulting in a ranking of 3 in Table II. NAICS code 22111 has an average Gross Margin of 36%, which is close to the average of 35% across all codes, and corresponds to a ranking of 3 in Table III.

The total score for NAICS code 22111 is computed as:

$$\begin{matrix}Total Score = 0.4 * 4 + 0.3 * 3 + 0.3 * 3 \\ = 1.6 + 0.9 + 0.9 \\ = 3.4\end{matrix}$$

The volume for total sales in NAICS code 22111 is $45.9 Billion. This is clearly worthy of sales efforts for a financial product that can be used by the buyers of goods and services and accepted by the sellers. In addition, the top ten code 22111 organizations can be targeted for sales as organizations that accept the financial product.

Thus, the model as described above, and as illustrated in the portion of the spreadsheet of FIGS. 3A and 3B takes into account ability and need (as measured by bad debt and DSO). The score may be compared to total sales volume to make a decision as to whether one or more organizations in a particular industry are worth pursuing in terms of the reward for having them use or accept the use by others of a financial product to improve cash flow, and make the organization more profitable.

It may also be appropriate, in deciding which industries or businesses to target for sale of a particular financial product, to taking into account average transaction size, because business to business transactions over a certain dollar amount typically do not take place on payment cards. In general, companies with a high volume of lower value transactions will be more open to the use of a payment card under given pricing considerations.

It will be understood that the present disclosure may be embodied in a computer readable non-transitory storage medium storing instructions of a computer program which when executed by a computer system results in performance of steps of the method described herein. Such storage media may include any of those mentioned in the description above.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof.

What is claimed is:

1. A computer system comprising:
a memory for storing data of the length of time after completion of a sale an organization receives payment for the sale, whether the organization receives payment for the sale and a profit margin to the organization for the sale; and
a processor for using the data to compute whether the organization can use a financial product to assist in operation of the organization based on the length of time after completion of the sale the organization receives payment, and the profit margin of the organization.

2. The system of claim 1, wherein the processor computes the length of time after completion of a sale payment is received based on average number of days a sale is outstanding.

3. The system of claim 1, wherein the processor computes a number to indicate whether the organization can use a financial product to assist in operation of the organization.

4. The system of claim 3, wherein the processor computes the number by:
multiplying a bad debt ranking by a first weighting factor to compute a first result;
multiplying a delay ranking indicative of the length of time after making a sale payment is received by a second weighting factor to compute a second result;
multiplying an ability to pay for the financial product ranking by a third weighting factor to compute a third result; and
adding the first result, the second result and the third result to determine the number.

5. The system of claim 4, wherein the delay ranking is determined from a table with first entries for average number of days sales are outstanding for the organization, and second entries for delay ranking.

6. The system of claim 5, wherein the ability ranking is determined from a table with first entries for profit margin of the organization, and second entries representative of ability ranking for each of the first entries.

7. The system of claim 5, wherein the bad debt ranking is determined from a table with first entries for percentage of bad debt of the organization, and second entries representative of bad debt ranking for each of the first entries.

8. The system of claim 1, wherein the financial product includes use or acceptance of one or more payment cards selected from the group consisting of credit cards, debit cards and prepaid cards.

9. The system of claim 1, wherein:
the organization is one of a plurality of organizations in a group of organizations having the same North American Industry Classification System code;
the memory stores data of the length of time after completion of sales the organizations receive payment for the sales, whether the organizations receive payment for the sales and a profit margin to the organizations for the sales; and
the processor use the data to compute whether the organizations can use the financial product to assist in operation of the organizations based on how long after completion of the sales the organizations receive payment, whether the organizations receive payment for the sales and the profit margin of the organizations.

10. A method implemented with a computer, comprising:
storing in a memory data of the length of time after completion of a sale an organization receives payment for the sale, whether the organization receives payment for the sale and a profit margin to the organization for the sale; and
using a processor to process the data to compute whether the organization can use a financial product to assist in operation of the organization based on how long after completion of the sale the organization receives payment, and the profit margin of the organization.

11. The method of claim 10, wherein computing the length of time after completion of a sale payment is received is based on average number of days a sale is outstanding

12. The method of claim 10, wherein the computing comprises determining a number to indicate whether the organization can use a financial product to assist in operation of the organization.

13. The method of claim 12, wherein the number is computed by:
multiplying a bad debt ranking by a first weighting factor to compute a first result;
multiplying a delay ranking indicative of the length of time after making a sale payment is received by a second weighting factor to compute a second result;
multiplying an ability to pay for the financial product ranking by a third weighting factor to compute a third result; and
adding the first result, the second result and the third result to determine the number.

14. The method of claim 13, wherein the delay ranking is determined by accessing a table with first entries for average number of days sales are outstanding for the organization or group of organizations, and second entries for delay ranking.

15. The method of claim 13, wherein the ability to pay for the financial product ranking is determined from a table with first entries for profit margin of the organization, and second entries representative of ability ranking for each of the first entries.

16. The method of claim 13, wherein the bad debt ranking is determined by accessing a table with first entries for percentage of bad debt of the organization, and second entries representative of bad debt ranking for each of the first entries.

17. The method of claim 10, wherein the organization is one of a plurality of organizations in a group of organizations having the same North American Industry Classification System code;
the memory stores data of the length of time after completion of sales the organizations receive payment for the sales and a profit margin of the organizations; and
the computing is whether the organizations can use the financial product to assist in operation of the organizations based on the length of time after completion of the sales the organizations receive payment, and the profit margin of the organizations.

18. A computer readable non-transitory storage medium storing instructions of a computer program which when executed by a computer system results in performance of steps of a method, comprising:
storing in a memory data of the length of time after completion of a sale an organization receives payment for the sale, whether the organization receives payment for the sale and a profit margin of the organization; and
processing the data to compute whether the organization can use a financial product to assist in operation of the organization based on the length of time after completion of the sale the organization receives payment, and the profit margin of the organization.
